(19) United States
(12) Patent Application Publication
(10) Pub. No.: US 2013/0082552 A1
(43) Pub. Date: Apr. 4, 2013

(54) STARTER INCLUDING NOISE REDUCTION FILTER

(71) Applicant: Yoichi Shoji, Anjo-shi (JP)

(72) Inventor: Yoichi Shoji, Anjo-shi (JP)

(73) Assignee: DENSO CORPORATION, Kariya-city (JP)

(21) Appl. No.: 13/553,132

(22) Filed: Jul. 19, 2012

(30) Foreign Application Priority Data
Oct. 4, 2011 (JP) 2011-219919

(51) Int. Cl. H02K 11/02

(52) U.S. Cl. 310/71; 310/72

(57) ABSTRACT

The starter includes an electromagnetic switch including an electrical contact interposed in a power supply line through a battery terminal and a motor terminal, a motor for generating torque by being supplied with electric power through the power supply line when the electrical contact is closed, and a noise reduction filter connected to the power supply line. The noise reduction filter includes a capacitor, a positive side lead plate connected to a first end of the capacitor and a negative side lead plate connected to a second end of the capacitor, the positive side lead plate being connected to the motor terminal through a lead wire, the negative side lead plate being fixed and connected to a frame of the motor. The frame of the motor is fitted with a lead wire fixing section made of insulating material for holding and fixing the lead wire.

This application claims priority to Japanese Patent Application No. 2011-219919 filed on Oct. 4, 2011, the entire contents of which are hereby incorporated by reference.

### BACKGROUND OF THE INVENTION

1. Field of the Invention

The present invention relates to a starter including a noise reduction filter for reducing noise emitted from a motor of the starter.

2. Description of Related Art

There is an increasing number of vehicles provided with a system for automatically stopping the engine by cutting supply of fuel to the engine when the vehicle is stopped at an intersection for example (the system being generally called “idling stop system”) in order to reduce carbon dioxide emission and improve fuel economy of the vehicle. When a vehicle driver of such a vehicle performs an operation to start the vehicle after the engine was stopped by the idling stop system, the starter of the vehicle starts to operate to automatically start the engine in accordance with a command received from an ECU (Electronic Control. Unit). Meanwhile, if the starter is of the type including a commutator motor, since sparks occur between the commutator and brushes when the motor is rotating, it may occur that the vehicle driver and passengers feel uncomfortable each time the engine is automatically restarted because such sparks cause noise in a radio receiver or the like. German patent application laid-open. No. 102008001570 describes a structure where a noise reduction filter including a capacitor circuit is connected in parallel with a motor of a starter to cope with this problem.

However, in this structure, the noise reduction filter is electrically and mechanically connected to the motor terminal of an electromagnetic switch of the starter through a metal terminal connected to the brushes of the motor and drawn outside the starter. Accordingly, a step to connect the noise reduction filter to the motor terminal of the electromagnetic switch is carried out in the starter assembling line. For starters whose metal terminal is not drawn outside, it is not possible to carry out the step to connect the noise reduction filter to the motor terminal of the electromagnetic switch of the starter in the starter assembling line. It is possible to retrofit the noise reduction filter even for such starters if the noise reduction filter is connected to the motor terminal of the electromagnetic switch through a lead wire.

However, in this case, it is necessary to take some measures to prevent the lead wire from being broken due to vibration or the like.

### SUMMARY

An exemplary embodiment provides a starter including:

an electromagnetic switch including an electrical contact interposed in a power supply line through a battery terminal and a motor terminal, and configured to open and close the electrical contact in interlock with on/off operation of a solenoid thereof;

a motor for generating torque by being supplied with electric power through the power supply line when the electrical contact is closed; and

a noise reduction filter connected to the power supply line in parallel with the motor for reducing noise emitted from the motor,

wherein

the noise reduction filter includes at least one capacitor, a positive side lead plate connected to a first end of the capacitor and a negative side lead plate connected to a second end of the capacitor, the positive side lead plate being connected to the motor terminal through a lead wire, the negative side lead plate being fixed and connected to a frame of the motor, and

the frame of the motor is fitted with a lead wire fixing section made of insulating material for holding and fixing the lead wire.

According to the exemplary embodiment, there is provided a starter having the structure where a noise reduction filter is connected to an electromagnetic switch through a lead wire, and being capable of preventing the lead wire from being broken due to vibration or the like, and preventing occurrence of short circuit to ground even if the lead wire is broken.

Other advantages and features of the invention will become apparent from the following description including the drawings and claims.

### BRIEF DESCRIPTION OF THE DRAWINGS

In the accompanying drawings:

FIG. 1 is a rear view of a starter including a noise reduction filter according to an embodiment of the invention;

FIG. 2 is a side view of the starter according to the embodiment of the invention;

FIG. 3 is a cross-sectional view of FIG. 1 taken along line A-A; and

FIG. 4 is an electrical circuit diagram of the starter according to the embodiment of the invention.

### PREFERRED EMBODIMENTS OF THE INVENTION

### First Embodiment

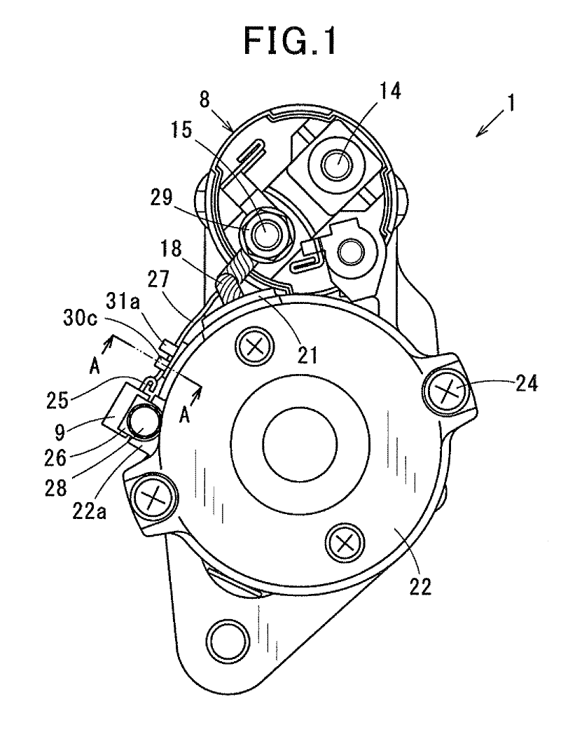

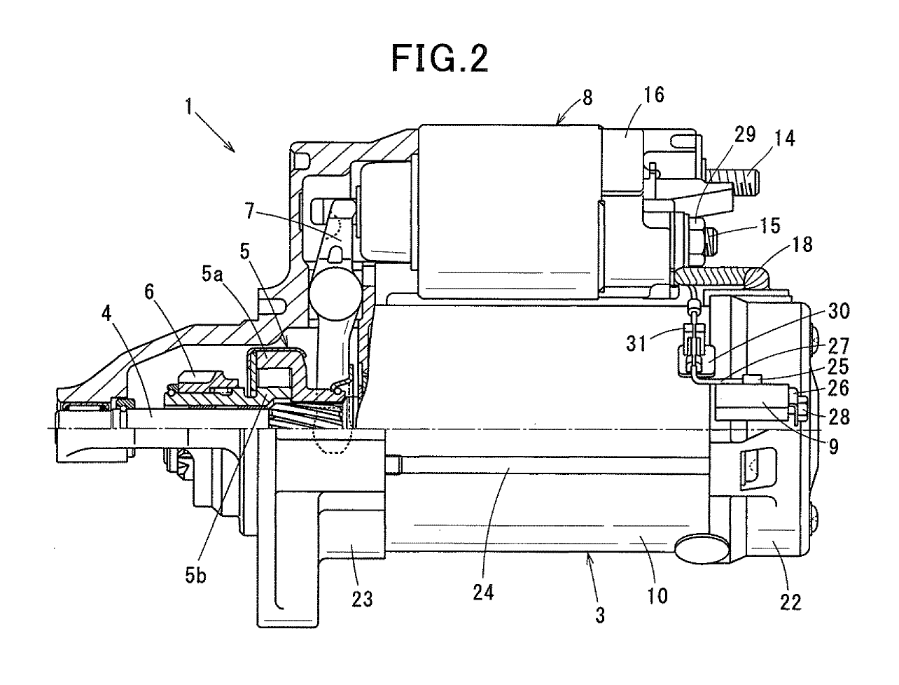

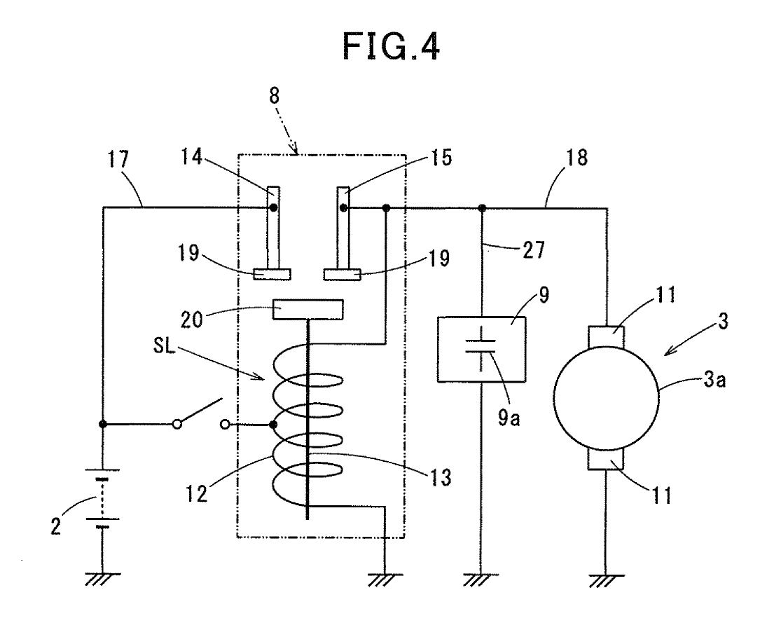

FIG. 1 is a rear view of a starter 1 according to an embodiment of the invention. As shown in FIG. 2, the starter 1 includes a motor 3, an output shaft 4, a clutch 5, a pinion 6, a shift lever 7, an electromagnetic switch 8 and a noise reduction filter 9. The motor 3 generates torque when supplied with power from a battery 2 (see FIG. 4). The output shaft 4 is driven by the motor 3. The rotation of the output shaft 4 is transmitted to the pinion 6 through the clutch 5. The electromagnetic switch 8 drives the shift lever 7 using attraction force of an electromagnet thereof to push out the pinion 6 integrally with the clutch 6 in the opposite motor direction (the leftward direction in FIG. 2), and interrupts a current supplied to the motor 3 by opening and closing a later-explained main contact. The noise reduction filter 9 is for suppressing noise emitted from the motor 3.

The motor 3 is a DC commutator motor including a field system constituted of permanent magnets or a field winding disposed inside a yoke 10 forming a magnetic circuit, an armature 3a (see FIG. 4) rotatably disposed inside the field system and brushes 11 (see FIG. 4) which slide on the outer periphery of a commutator when the armature 3a rotates. The output shaft 4 is disposed coaxially with the armature 3a by the provision of a not-shown reduction gear (a planetary reduction gear, for example). The torque generated by the motor 3 and increased by the reduction gear is transmitted to the output shaft 4 causing the output shaft 4 to rotate. The clutch 5 is a one-way clutch which transmits the torque of the output shaft 4 from the outer 5a thereof to the inner tube 5b thereof, while interrupting torque transmission from the inner tube 5b to the outer 5a. The pinion 6 is spline-fitted to the outer periphery of the inner tube 5b so that it rotates together with the inner tube 5b.

As shown in FIG. 4, the electromagnetic switch 8 includes terminal bolts 14 and 15, a solenoid SL having an excitation coil 12, a plunger 13 and a resin cover 16 (see FIG. 2). The terminal bolts 14 and 15 are fixed to the resin cover 16. The solenoid SL serves as an electromagnet for attracting the plunger 13 when the excitation coil 12 is energized. The main contact is disposed inside the resin cover 16. The terminal bolt 14 is a B-terminal bolt (battery terminal) connected to the positive terminal of the battery 2 through a cable 17. The terminal bolt 15 is an M-terminal bolt (motor terminal) connected to the positive side brush 11 through a motor lead 18. As shown in FIG. 4, the main contact is constituted of a pair of fixed contacts 19 and a movable contact 20. The fixed contacts 19 are interposed in a power supply line of the motor 3 through the B-terminal bolt 14 and the M-terminal bolt 15. The movable contact 20 makes and breaks electrical connection between the fixed contacts 19 in interlock with movement of the plunger 13.

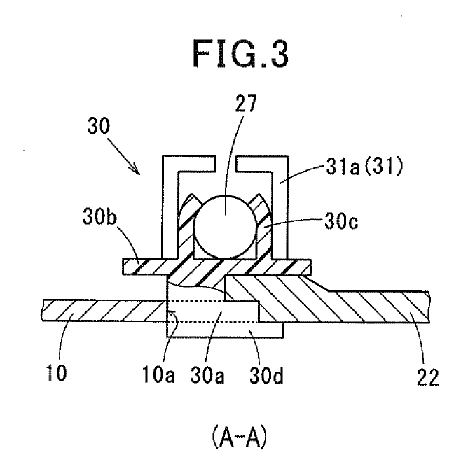

As shown, in FIG. 1, the motor lead 18 is connected to the positive side brush 11 at its one end inserted through a gum grommet 21 fitted to the frame of the motor 3 and drawn inside the frame, and is connected to the M-terminal bolt 15 at its other end drawn outside through the grommet 21. Incidentally, in a case where the field system of the motor 3 is constituted of not permanent magnets but a field winding, it is possible to connect one end of the motor lead 18 to the field winding through a connection bar. As shown in FIG. 3, the frame of the motor 3 is constituted of the yoke 10 and an end frame 22 fitted to the opening of the rear end (the right end in FIG. 3) of the yoke 10 so as to close the opening. The end frame 22 is fixed to a front housing 23 of the starter 1 by tightening through bolts 24.

The noise reduction filter 9 includes at least one capacitor 9a (see FIG. 4), a positive side lead plate 25 connected to one end of the capacitor 9a and a negative side lead plate 26 connected to the other end of the capacitor 9a. The noise reduction filter 9 is connected to the power supply line through the lead plates 25 and 26 in parallel with the motor 3. More specifically, as shown in FIG. 1, the positive side lead plate 25 is connected to the M-terminal bolt 15 of the electromagnetic switch 8 through a lead wire 27, and the negative side lead plate 26 is fixed to the end frame 22 of the motor 3. The negative side lead plate 26 is fixed to a pedestal 22a integrally formed in the end frame 22 by tightening a bolt 28.

As shown in FIG. 1, one end (referred to as a first end hereinafter) of the lead wire 27 is connected and fixed to an end of the positive side lead plate 25 by swaging or the like. The other end (referred to as a second end hereinafter) of the lead wire 27 is shaped in a ring and fitted to the M-terminal bolt 15. By tightening a nut 29 to the M-terminal bolt 15, the lead wire 27 is fixed to the M-terminal bolt 15 together with the terminal of the motor lead 18. As shown in FIG. 2, the lead wire 27 is fixed by a lead wire fixing section 30 at a portion near the first end connected to the positive side lead plate 25 (or at a portion closer to the first end than to the center portion between the first and second ends), and is held by a lead wire holding section 31 at a portion closer to the second end (the M-terminal bolt 15 side) than to the lead wire fixing section 30. The lead wire fixing section 30, which is made of insulating material such as resin, is constituted of a fitting section 30a for fitting to the frame of the motor 3, a plate-like brim section 30b disposed outside the frame of the motor 3 and a pair of arm sections 30c disposed standing from the surface of the brim section 30b. The lead wire 27 passing on the surface of the plate-like brim section 30b is held by the pair of the arm sections 30c.

The fitting section 30a is inserted into a U-shaped notch formed in the rear end surface of the yoke 10. The fitting section 30a is fixed between the notch 10a of the yoke 10 and the mating end surface of the end frame 22 by mating the end frame 22 to the opening of the yoke 10. A brim-like section 30d is integrally formed in the fitting section 30a on the side opposite to the plate-like brim section 30b (on the lower side of FIG. 2). The brim-like section 30d is in contact with the periphery of the notch 10a and the inner periphery of the end frame 22. The plate-like brim section 30b is disposed outside the end frame 22 such that the end frame 22 is held in the through-thickness direction between the plate-like brim section 30b and the brim-like section 30d. The plate-like brim section 30b provides insulation between the yoke 10 and the end frame 22 over a certain length.

The pair of the arm sections 30c are disposed at an interval nearly equal to the outer diameter of the lead 27 such that their front end portions are inclined or curved in a direction to approach each other. Accordingly, the width of the opening formed between the front end portions of the arm sections 30c is smaller than the outer diameter of the lead wire 27. Since the front end portions of the arm sections 30c are inclined or curved inwardly in a direction to approach each other, the lead wire 27 inserted between the front end portions of the arm sections 30c can be held by being pressed to the plate-like brim section 30b. That is, since the front end portions of the arm sections 30c inclined or curved inwardly to hold back the lead wire 27, the lead wire 27 can be prevented from moving away from the surface of the plate-like brim section 30b, and be fixed reliably between the arm sections 30c.

The lead holding section 31 includes a pair of guide pieces 31a disposed standing from the surface of the brim section 30b. The lead wire 27 is guided between the guide pieces 31a. As shown in FIG. 3, the pair of the guide pieces 31a are disposed at an interval larger than the outer diameter of the lead wire 27 such that their front end portions are bent in a hook shape in a direction to approach each other. Unlike the lead wire fixing section 30, the lead holding section 31 does not fix the lead wire 27, but prevents the lead wire 27 from swinging to a large extent due to vibration between the lead fixing section 30 and the M-terminal bolt 15. Further, in the unlikely event that the lead wire 27 is broken between the lead wire fixing section 30 and the lead holding section 31, the lead wire holding section 31 prevents a broken portion of the lead wire 27 from contacting the frame of the motor 3 (the yoke 10 and the end frame 22).

The above described embodiment of the invention provides the following advantages. The noise reduction filter 9 is fixed to the pedestal 22 provided in the end frame 22 of the motor 3 at the pedestal 22a integrally formed in the negative side lead plate 26 by tightening the bolt 28, and connected to the M-terminal bolt 15 of the electromagnetic switch 8 at the positive side lead plate 25 through the lead wire 27. According to this structure, it becomes unnecessary to perform connection of the noise reduction filter 9 in the assembly line of the starter 1, because the noise reduction filter 9 can be mounted on the starter 1 after the starter 1 has been assembled. Hence, according to this embodiment, it is not necessary to make a change to the existing assembling line of the starter 1. More specifically, according to this embodiment, it is possible to connect the noise reduction filter 9 to the M-terminal bolt 15 of the electromagnetic switch 8 through the lead 27. Further, since the lead wire 27 for connecting the noise reduction filter 9 to the M-terminal bolt 15 is securely fixed by the lead fixing section 30 fitted to the frame of the motor 3, it is possible to reliably prevent the lead wire 27 from being broken due to vibration.

Further, since the lead holding section 31 is provided in the vicinity of the lead wire fixing section 30, in the unlikely event that the lead 27 is broken between the lead wire fixing section 30 and the lead wire holding section 31, it is possible to prevent a broken portion of the lead wire 27 from contacting the frame of the motor 3 (the yoke 10 and the end frame 22). Accordingly, according to this embodiment, it is possible to ensure reliability of the noise reduction filter 9 in the structure where the noise reduction filter 9 is connected to the M-terminal bolt 15 of the electromagnetic switch 8 through the lead wire 27.

The noise reduction filter 9 can be fitted easily to the end frame 22 of the motor 3 utilizing the negative side lead plate 26 without using an additional part such as a stay, and be fixed to the pedestal 22a of the end frame 22 at the negative side lead plate 26 even in the structure where the noise reduction filter 9 is connected to the M-terminal bolt 15 of the electromagnetic switch 8 through the lead wire 27. Accordingly, according to this embodiment, it is possible to improve resistance to vibration of the starter. The lead wire fixing section 30 can be attached easily to the frame of the motor 3 only by inserting, the fitting section 30a between the yoke 10 and the end frame 22, and can be reliably prevented from coming off the frame of the motor 3 due to vibration or the like

### Modifications

The lead wire holding section 31 may be formed separately from the lead wire fixing section 30. In this case, the lead wire holding section 31 can be fixed by being inserted between the yoke 10 and the end frame 22 like the lead wire fixing section 30. In the above embodiment, the lead wire holding section 31 is provided in one place. However, the lead wire holding section 31 may be provided in two or more places. The lead wire holding section 31 may be disposed between the lead fixing section 30 and the positive side lead plate 25. The lead wire fixing section 30 and the lead wire holding section 31 may be made of insulating material other than resin such as gum.

The above explained preferred embodiments are exemplary of the invention of the present application which is described solely by the claims appended below. It should be understood that modifications of the preferred embodiments may be made as would occur to one of skill in the art.

What is claimed is:

1. A starter comprising:
an electromagnetic switch including an electrical contact interposed in a power supply line through a battery terminal and a motor terminal, and configured to open and close the electrical contact in interlock with on/off operation of a solenoid thereof;
a motor for generating torque by being supplied with electric power through the power supply line when the electrical contact is closed; and
a noise reduction filter connected to the power supply line in parallel with the motor for reducing noise emitted from the motor,
wherein
the noise reduction filter includes at least one capacitor, a positive side lead plate connected to a first end of the capacitor and a negative side lead plate connected to a second end of the capacitor, the positive side lead plate being connected to the motor terminal through a lead wire, the negative side lead plate being fixed and connected to a frame of the motor, and
the frame of the motor is fitted with a lead wire fixing section made of insulating material for holding and fixing the lead wire.

2. The starter according to claim 1, wherein the lead wire fixing section includes a plate-like brim section interposed between the frame and the lead wire, and a pair of arm sections standing from a surface of the plate-like brim section on the side opposite to the frame, the lead wire passing on the surface of the plate-like brim section being held and fixed by the pair of the arm sections.

3. The starter according to claim 1, further comprising at least one lead wire holding section for holding the lead wire between the lead wire fixing section and the motor terminal or between the lead wire fixing section and the positive side lead plate, the lead wire holding section being fitted to the frame integrally formed with or separately from the lead wire fixing section.

4. The starter according to claim 1,
wherein
the frame of the motor includes a cylindrical yoke serving as a magnetic circuit and an end frame closing an opening of the yoke that opens at one end thereof, and
the lead wire fixing section includes a fitting section for fitting to the frame, the fitting section being held and fitted between the yoke and the end frame.

5. The starter according to claim 1, wherein the noise reduction filter is screwed, at the negative side lead plate, to a pedestal integrally formed in the frame.
